(19) United States
(12) Patent Application Publication
(10) Pub. No.: US 2023/0366434 A1
(43) Pub. Date: Nov. 16, 2023

(54) SEALER FOR BEARING BUSHINGS FOR HINGES OF A VEHICLE

(71) Applicant: MAGNA CLOSURES INC., NEWMARKET (CA)

(72) Inventors: SASCHA KULLICK, NEWMARKET (CA); STEPHAN HOLSCHBACH, NEWMARKET (CA)

(21) Appl. No.: 18/142,473

(22) Filed: May 2, 2023

Related U.S. Application Data
(60) Provisional application No. 63/340,644, filed on May 11, 2022.

(51) Int. Cl. F16C 33/74; F16C 43/02

(52) U.S. Cl. CPC F16C 33/74; F16C 43/02; F16C 2361/00

(57) ABSTRACT

A bearing assembly for coupling a pair of link members of a hinge to one another, the assembly including: a bushing having a bushing body, the bushing body including a metallic material and having a plurality of surfaces; and a sealer coating applied over at least one surface of the plurality of surfaces, such that the sealer coating exhibits a material property of paint repellant for paint material when the paint material is applied during a subsequent cathodic painting process.

### CROSS REFERENCE TO RELATED APPLICATION

This application claims the benefit of U.S. Provisional Application No. 63/340,644 filed May 11, 2022.

### FIELD

The present invention relates to bearing systems.

### BACKGROUND

It is well know the problem of paint bridge formation during the painting of assembled hinges. In particular, these paint bridges can be undesirably caused by the sticking of applied paint to the bushings of the hinge. Paint bridges are a concern, as hardened paint of the paint bridge can become dislodged during subsequent operation of the hinge, which can cause issues with dislodged paint particles being distributed in the environment as well as on the finished car itself. Presence of the dislodged paint particles on the car can require that the paint job be reworked before selling of the car.

Further, this paint bridge problem is exacerbated by the use of metal containing bushings in the car industry, as the painting can also become attached to the bushings during the painting process. In this manner, any tearing of the applied paint material during subsequent articulation of the hinge can undesirably expose the actual body of the hinge adjacent to the bushing to the environment (e.g. considered corrosive to the material of the body).

### SUMMARY

It is an object to the present invention to provide a bushing assembly to obviate or mitigate at least one of the above-mentioned problems.

A first aspect provided is a bearing assembly for coupling a pair of link members of a hinge to one another, the assembly including: a bushing having a bushing body, the bushing body including a metallic material and having a plurality of surfaces; and a sealer coating applied over at least one surface of the plurality of surfaces, such that the sealer coating exhibits a material property of paint repellant for paint material when the paint material is applied during a subsequent cathodic painting process.

A second aspect provided is a bearing assembly for coupling a pair of link members of a hinge to one another, the hinge connected to a vehicle closure panel, the assembly including: a bushing having a bushing body, the bushing body including a metallic material and having a plurality of surfaces; and a sealer coating applied over at least one surface of the plurality of surfaces, such that the sealer coating exhibits a material property of paint repellant for paint material when the paint material is applied during a cathodic painting process.

A third aspect provided is a method of manufacturing a bearing assembly, the method comprising: applying a sealer coating over at least one surface of a plurality of surfaces of a bushing body of a bushing of the bearing assembly, such that the sealer coating exhibits a material property of paint repellant for paint material when the paint material is applied during a subsequent cathodic painting process, the bushing body including a metallic material; wherein the bushing when installed in a link member the hinge provides for paint repellant properties of the bearing assembly.

A fourth aspect provided is a method of manufacturing a hinge including a bearing assembly, the method comprising: applying a sealer coating over at least one surface of a plurality of surfaces of a bushing body of a bushing of the bearing assembly, such that the sealer coating exhibits a material property of paint repellant for paint material when the paint material is applied during a subsequent cathodic painting process, the bushing body including a metallic material; installing the bushing in a link member of the hinge; and installing a fastener in an aperture of the bushing for coupling the link member to another link member of the hinge.

A fifth aspect provided is a hinge assembly for coupling a closure panel to a body of a vehicle, the hinge comprising: a body side bracket for coupling to the body of the vehicle; a closure panel side bracket for coupling to the closure panel; at least one link member coupling the body side bracket to the closure panel side bracket; and a bushing positioned between positioned between the at least one link member and the at least one of the closure panel side bracket and body side bracket, wherein at least a portion of the bushing is coated to inhibit the adhesion of paint to the bushing.

In yet another aspect, provided is a bearing assembly for coupling a pair of link members to one another, the assembly including a bushing having a bushing body, the bushing body including a material and having a plurality of surfaces, and a sealer coating applied over at least one surface of the plurality of surfaces, such that the sealer coating exhibits a material property of paint repellant for paint material when the paint material is applied during a subsequent painting process.

Further aspects provided are a hinge assembly wherein an outer surface of the bushing is coated to inhibit the adhesion of paint to the bushing, and a hinge assembly wherein the outer surface of the bushing is coated with a layer of paint repellant material.

### BRIEF DESCRIPTION OF THE DRAWINGS

The foregoing and other aspects will be more readily appreciated having reference to the drawings, wherein:

FIG. 1 is a perspective view of a vehicle with an example latch system for a closure panel;

FIG. 2 is an example hinge the vehicle of FIG. 1;

FIG. 3 is an unassembled hinge of FIG. 1;

FIG. 4 is an assembled hinge of FIG. 1;

FIG. 5 is a cross sectional view of an embodiment of the bushing of the hinge of FIG. 1;

FIG. 6 is perspective view of a painted hinge without a sealer coat of the vehicle of FIG. 1;

FIG. 7 is a cross sectional view of one embodiment of the bushing of FIG. 3;

FIG. 8 is a cross sectional view of a further embodiment of the bushing of FIG. 3;

FIG. 9 is a cross sectional view of a further embodiment of the bushing of FIG. 3;

FIG. 10 is a cross sectional view of a further embodiment of the bushing of FIG. 3;

FIG. 11 is a perspective view of a portion of the bushings of FIGS. 7, 8, 9 and 10; and

FIG. 12 is a flowchart of an example operation of manufacturing the bushing and incorporation of same in the hinge of FIG. 1.

### DETAILED DESCRIPTION OF THE PREFERRED EMBODIMENTS

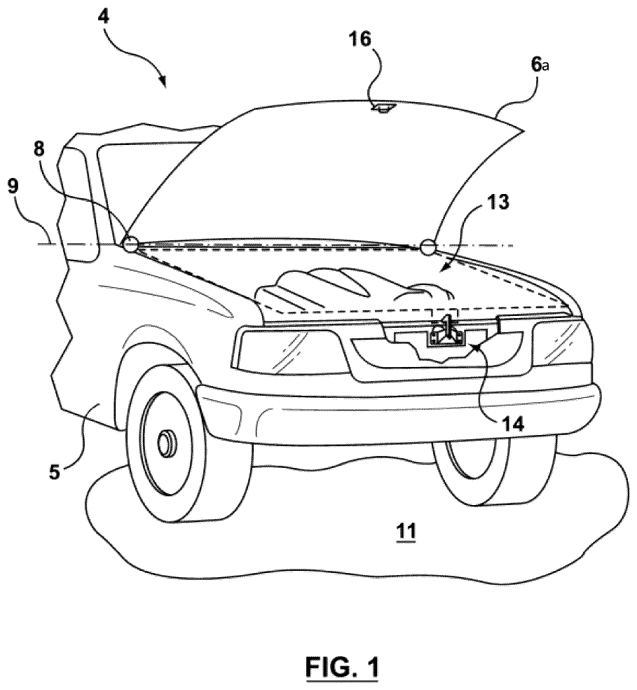

Referring to FIG. 1, shown is a vehicle 4 with a vehicle body 5 having one or more closure panels 6a. The closure panel 6a can be connected to the vehicle body 5 via one or more hinges 8 and retained by a latch assembly 14 in a closed position once closed. The closure panel 6a can have a mating latch component 16 (e.g. striker) mounted thereon for coupling with a respective latch assembly 14 mounted on the vehicle body 5. Alternatively, the latch assembly 14 can be mounted on the closure panel 6a and the mating latch component 16 mounted on the body 5 (not shown).

The hinges 8 provide for movement of the closure panel 6a between a closed panel position (shown in dashed outline) and an open panel position (shown in solid outline). In the embodiment shown, the closure panel 6a pivots between the open panel position and the closed panel position about a pivot axis 9 (e.g. of the hinge 8), which can be configured as horizontal or otherwise parallel to a support surface 11 of the vehicle 4. For vehicles 4, the closure panel 6 can be referred to as a partition or door, typically hinged, but sometimes attached by other mechanisms such as tracks, in front of an opening 13 which is used for entering and exiting the vehicle 4 interior by people and/or cargo.

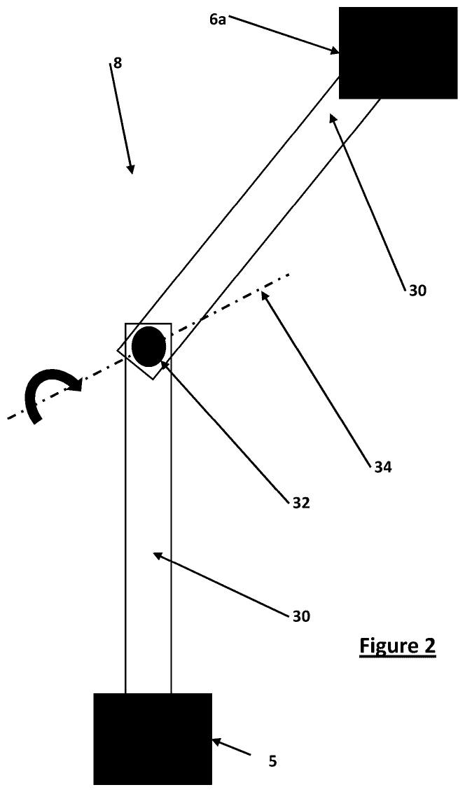

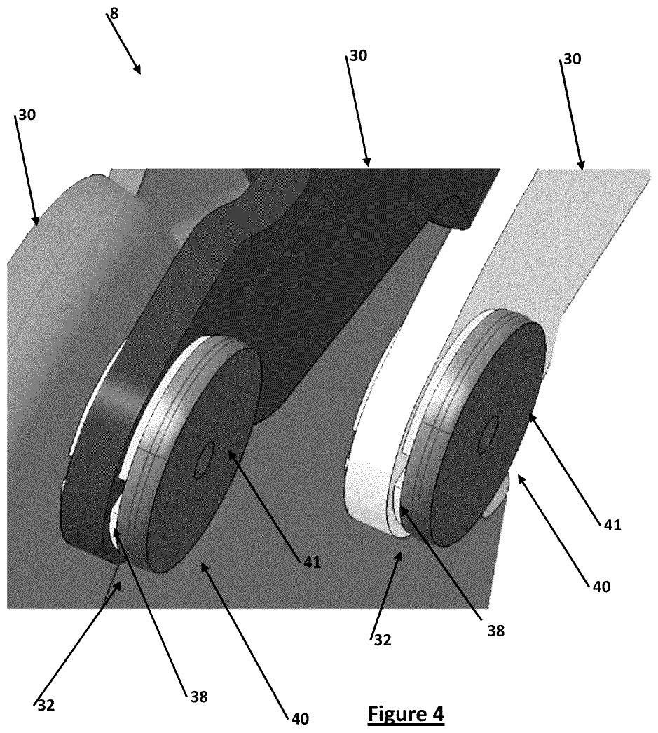

The hinges 8 typically contain two or more link members 30, see FIG. 2, which can be coupled to one another by a bearing assembly 32 (see FIG. 4). Alternatively, it is recognized that the link member(s) 30 could also be connected to the body 5 of the vehicle 4, and/or the closure panel 6a of the vehicle 4, via respective bearings 32. In any event, the presence of the bearing 32 facilitates the link members 30 articulating (e.g. rotating) with respect to one another about a pivot axis 34 of the bearing, as the hinge 8 is operated during movement of the closure panel 6a between the open and closed positions.

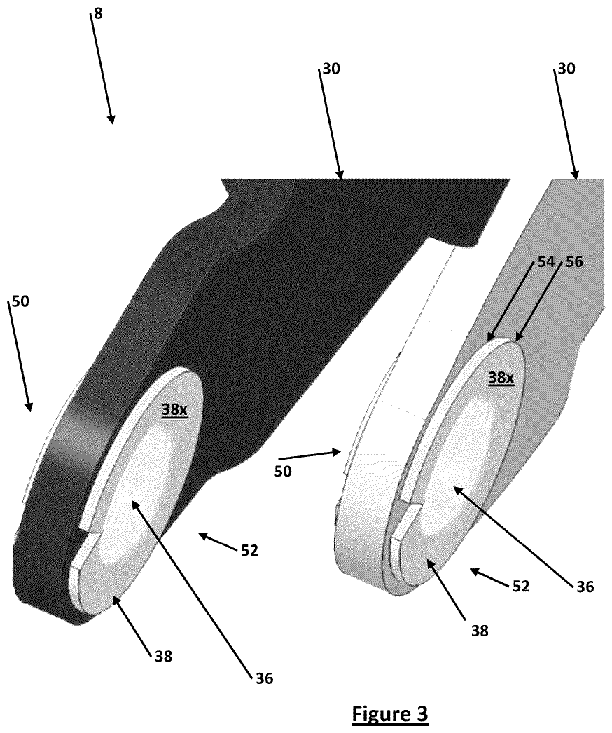

Referring to FIG. 3, shown is an unassembled portion of the hinge 8, such that the link members 30 are disconnected from one another. Also shown is an aperture 36 in each link member 30, with a respective bushing 38 installed therein, such that the bushing has a first side 50 and a second side 52, such that each side 50, 52 are on opposite sides of the aperture 36. The bushings 38 typically are made of a metal material or at least have a metal core (e.g. a metal core surrounded by a nonmetallic—e.g. plastic—coating). In any event, it is recognized that the bushings 38 have at least some material component/portion of the bushing body 38x that is metallic, such that the material component/portion is exposed to the surrounding environment even when the hinge 8 is assembled, and thus the material component/portion exposed is attractive to paint particles deposited during an electrostatic painting process (as is known in the art).

Referring to FIG. 4, shown is a hinge 8 assembly having three link members 30 coupled to one another by a pair of rivets 40 mounted in their respective bushing 38. As such, the bearing assembly 32 can be comprised of a bushing 38 with an installed rivet 40 (e.g. fastener 40) therein. It is noted that in FIG. 4 only one side 52 of the rivet 40 is shown with rivet head 41, recognizing that typically there is a corresponding rivet head on the other side 52 of the bushing 38, not shown.

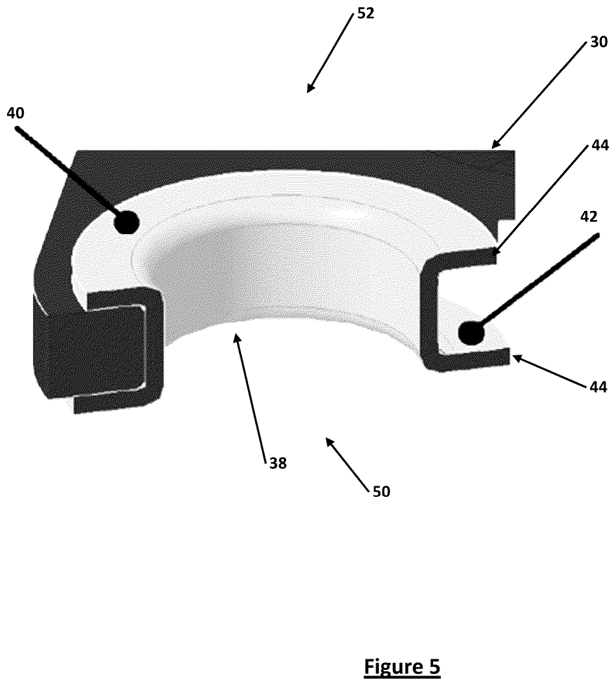

Referring to FIG. 5, shown is a cross section of a bushing 38 installed in the aperture 36 of the link member 30, with a portion of the link member 30 removed for ease of illustration only, such that the bushing 38 has an outside surface 40 and an inside surface 42, as well as an end surface 44 connecting the inside surface 42 to the outside surface 40. It is recognized that the inside surface 42 is positioned adjacent to and in contact with a body 30a (see FIG. 3) of the link member 30. Furthermore, the outside surface 40 is opposite to and spaced apart from the inside surface 42, such that the outside surface 40 is not in contact with the body 30a. Furthermore, the end surface 44 has a first portion 54 (see FIG. 3) in contact with the body 30a and the inside surface 42, and a second portion 56 (see FIG. 3) in contact with the outside surface 40 while also not in contact with the body 30a. For example, as shown in FIG. 5, the outside surface 40 can be of a U-shaped configuration and the inside surface 42 can also be of a U-shaped configuration, such that the surfaces 40, 42 are generally parallel to one another and spaced apart from one another.

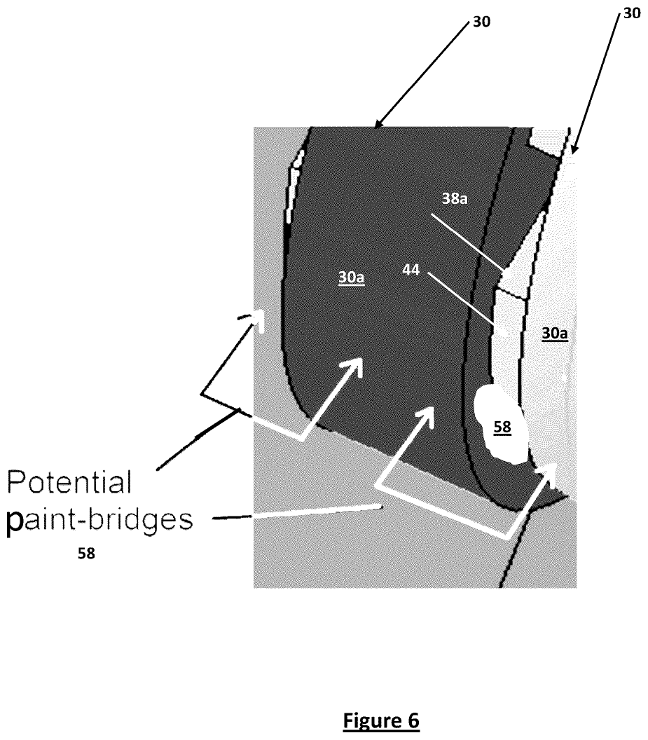

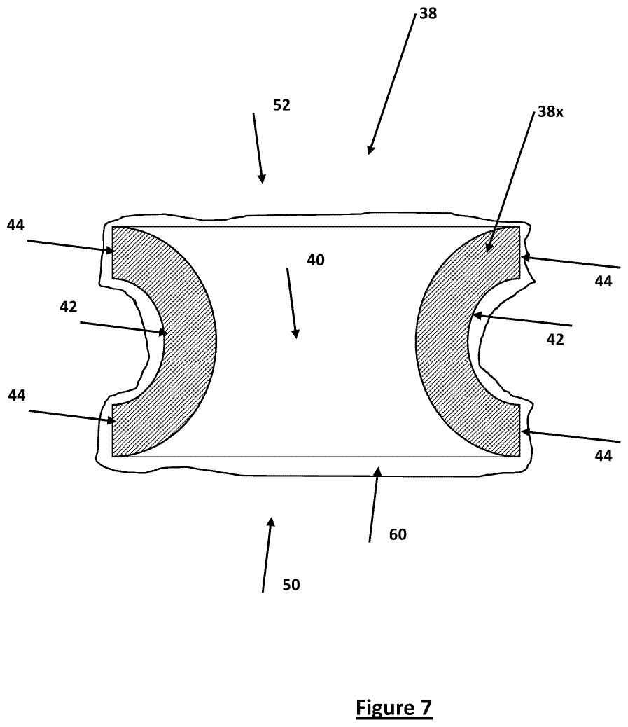

Referring to FIG. 6, shown is an installed bushing 38a of the bearing assembly 32, thus coupling the two link members 30 to one another for articulation (as shown in FIG. 2). However, the bushing 38a does not have a protective coating 60 (see FIG. 7) and thus during electrostatic painting of the body 30a of the hinge 8 (with bearings 32 installed), particles of paint material 58 can stick to the end surface 44, as this end surface 44 is exposed to the painting process. Further, as the surface 30a of the link member(s) 30 is also metallic, the paint material 58 can stick to both the surface(s) 30a adjacent to the bushing 38 as well as to the end surface 44 of the bushing 38. It is this overlap (e.g. also referred to as a paint bridge) of paint material 58, simultaneously present on both the surface(s) 30a and the end surface 44, which can cause the issues noted above (e.g. detachment of the paint bridge during subsequent operation of the hinge as the link members 32 articulate with respect to one another as well as the bushing 38 can move relative to the surface(s) 30a during the articulation).

Referring to FIG. 7, shown is a cross sectional view of a bushing 38, with surfaces 40, 42, 44 indicated. As shown, a coating 60 is provided over the surfaces 40, 42, 44, most importantly over the end surface 44. This coating 60 is referred to as a sealing coating 60, which has the material properties of being repellent to the paint material 58 (e.g. cathodic paint) applied to the assembled hinge 8 during the electrostatic painting process.

For example, cathodic coatings (e.g. paint material 58) involve coating metal (e.g. the surface of body 30a), which is cathodic with respect to the substrate in an electrochemical cell implemented during the painting process. Electrostatic painting uses positively-charged paint particles from a specialized gun to coat grounded metal surfaces 30a. The purpose of this type of paint coating is to protect the substrate (i.e. body 30a) from corrosion. In corrosive environments accelerated corrosion of the substrate (i.e. link members 30) can occur if the cathodic coating fails to protect the substrate. In this manner, any tearing of the paint material 58 during subsequent articulation of the hinge 8 can potentially undesirably expose the actual body 30a adjacent to the bushing 38 to the environment. Desired is to inhibit formation of the paint material 58 (e.g. paint bridge) and thus inhibit inadvertent damage to the integrity of the paint applied to the body 30a.

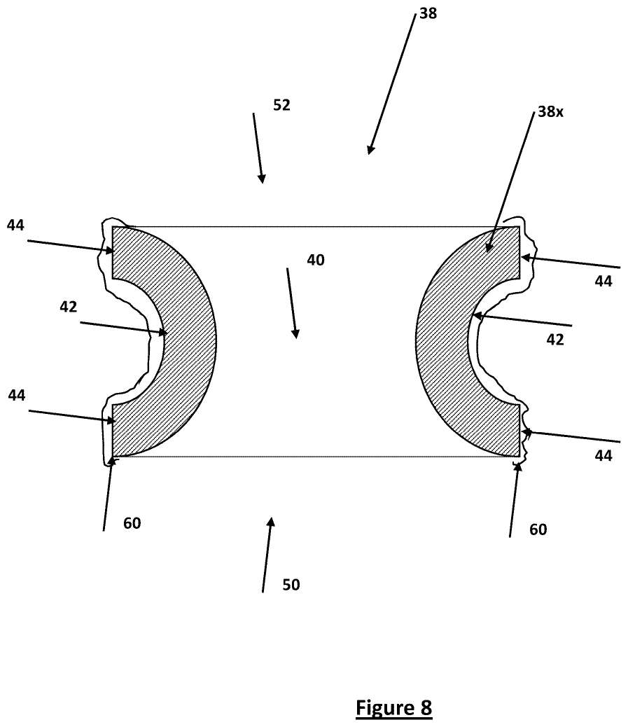

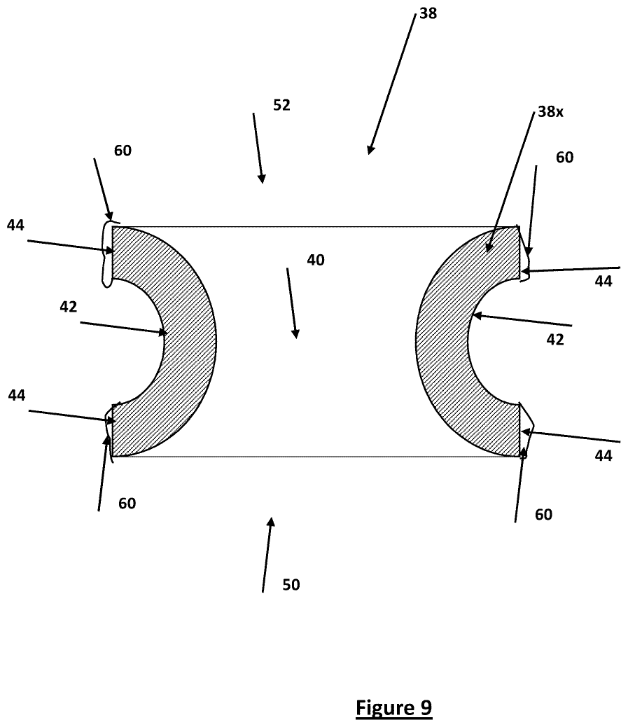

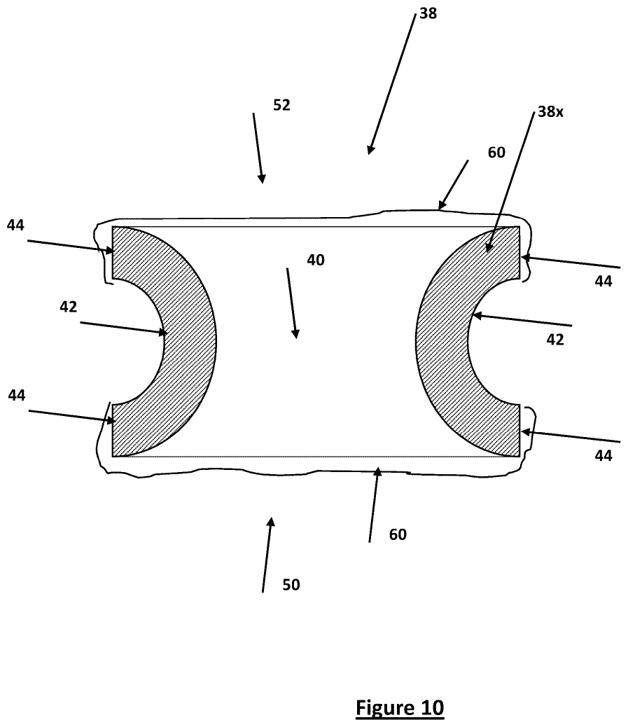

The sealer coating 60 can be made of a polymer material having a paint repellant quality. Referring to FIGS. 8, 9 and 10, shown are alternative embodiments of the sealer coating 60 on the surfaces 42, 44 only, on the surface 44 only, or on the surfaces 40, 44, respectively, as desired. It should be recognized that the thickness of the sealer coating 60 is not drawn to scale, for ease of illustration only.

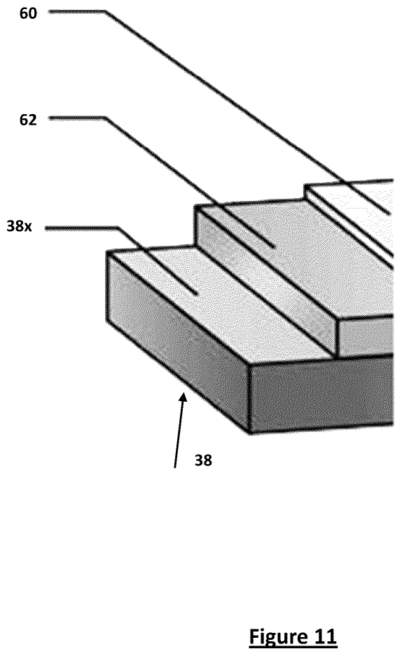

Referring to FIG. 11, shown is a representative portion of the bushing 38, showing the bushing body 38x, an antifriction coating 62 and the sealer coating 60. The antifriction coating 62 is on all of the surfaces 40, 42, 44, in order to inhibit friction generated between the bushing 38 and the rivet 40, and/or between the bushing and the body 30a of each of the adjacent link members 30. For example, friction is generated due to relative movement between the bushing 38 and the rivet 40 and/or relative movement between the bushing 38 and the body 30a of the link member 30, as the link members 30 move relative to one another during operation of the hinge 8. However, undesirably, the antifriction coating 62 while having desirable antifriction properties does not have preferable paint repellant properties, as desired. In other words, the antifriction coating 62 material has beneficial material properties for reducing the generation of friction but is not optimized for inhibiting the adherence of painting material 58 to the surfaces 40, 42, 44. It is noted that the thicknesses of the coatings 60, 62 in FIG. 11 are not to scale, and thus provided for ease of illustration purposes only.

Accordingly, optionally when antifriction coatings 62 are present on the bushing body 38x, the sealer coating 60 can be applied on top of this antifriction coating 62. Once the painting process has been completed, using the sealer coating 60 to inhibit formation of the paint material 58 (see FIG. 6), subsequent operation of the hinge 8 can either maintain the two coatings 60, 62, or if configured the sealer coating 60 can wear away or otherwise detach from the antifriction coating 62, due to generated friction, as the presence of sealer coating 60 is moot once the painting process has been completed.

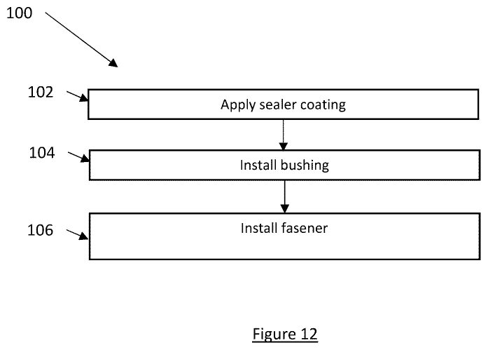

Referring to FIG. 12, a method 100 of manufacturing a hinge 8 including a bearing assembly 32, the method comprising: applying 102 a sealer coating 60 over at least one surface of a plurality of surfaces 40, 42, 44 of a bushing body 38x of a bushing 38 of the bearing assembly 32, such that the sealer coating 60 exhibits a material property of paint repellant for paint material 58 when the paint material 58 is applied during a subsequent cathodic painting process, the bushing body 38x including a metallic material; installing 104 the bushing 32 in a link member 30 of the hinge 8; and installing 106 a fastener 40 in an aperture 36 of the bushing 32 for coupling the link member 30 to another link member 30 of the hinge 8. A further step can be first applying the antifriction coating 62 prior to application of the sealer coating 60.

1. A bearing assembly (32) for coupling a pair of link members (30) of a hinge (8) to one another, the assembly including:
a bushing (38) having a bushing body (38x), the bushing body including a metallic material and having a plurality of surfaces (40, 42, 44); and
a sealer coating (60) applied over at least one surface of the plurality of surfaces, such that the sealer coating exhibits a material property of paint repellant for paint material (58) when the paint material is applied during a subsequent painting process.

2. The assembly of claim 1 further comprising an antifriction coating (62) applied on the at least one of the plurality of surfaces, such that the antifriction coating is between the bushing body and the sealer coating, wherein the antifriction coating exhibits a material property of friction inhibition during operation of the hinge.

3. The assembly of claim 1 further comprising the plurality of surfaces including an outside surface (40), an inside surface (42) and an end surface (44), such that the end surface is positioned between the outside surface and the inside surface.

4. The assembly of claim 3, wherein the at least one surface is the end surface.

5. The assembly of claim 3, wherein the at least one surface includes the outside surface, the inside surface and the end surface.

6. The assembly of claim 1 further including a fastener (40) inserted in an aperture (36) of the bushing, the fastener for joining the pair of link members to one another.

7. The assembly of claim 1, wherein the bushing has a generally a U shaped cross sectional shape.

8. The assembly of claim 1, wherein the hinge is mountable between a body (5) and a closure panel of a vehicle (4).

9. The assembly of claim 1, wherein the hinge is connectable to a vehicle closure panel (6a).

10. The assembly of claim 9, wherein the plurality of surfaces includes an outside surface (40), an inside surface (42) and an end surface (44), such that the end surface is positioned between the outside surface and the inside surface.

12. The assembly of claim 1, wherein the painting process is a cathodic painting process.

13. A method of manufacturing a bearing assembly, the method comprising:
applying a sealer coating over at least one surface of a plurality of surfaces of a bushing body of a bushing of the bearing assembly, such that the sealer coating exhibits a material property of paint repellant for paint material when the paint material is applied during a subsequent painting process, the bushing body including a metallic material;
wherein the bushing when installed in a link member the hinge provides for paint repellant properties of the bearing assembly.

14. The method of claim 13, wherein the plurality of surfaces includes an outside surface (40), an inside surface (42) and an end surface (44), such that the end surface is positioned between the outside surface and the inside surface.

15. The method of claim 13, wherein the painting process is a cathodic painting process.

16. The method of claim 13 further comprising applying an antifriction coating (62) on the at least one surface of the plurality of surfaces, such that the antifriction coating is positioned between the bushing body and the sealer coating, wherein the antifriction coating exhibits a material property of friction inhibition during operation of the bearing assembly.

17. A method of manufacturing a hinge assembly including a bearing assembly, the method comprising:
applying a sealer coating over at least one surface of a plurality of surfaces of a bushing body of a bushing of the bearing assembly, such that the sealer coating exhibits a material property of paint repellant for paint material when the paint material is applied during a subsequent cathodic painting process, the bushing body including a metallic material;
installing the bushing in a link member of the hinge; and
installing a fastener in an aperture of the bushing for coupling the link member to another link member of the hinge.

18. A method of claim 17 further comprising the step of coupling a closure panel to a body of a vehicle;
wherein the hinge assembly includes a body side bracket for coupling to the body of the vehicle, a closure panel side bracket for coupling to the closure panel, the link member coupling the body side bracket to the closure panel side bracket; and the bushing positioned between the link member and at least one of the closure panel side bracket and the body side bracket.

19. The method of claim 18, wherein an outer surface of the bushing is coated with the sealer to inhibit the adhesion of the paint material to the bushing.

20. The method of claim 18, wherein an outer surface of the bushing is coated with the sealer as a layer of the paint repellant material.
